(19) United States
(12) Patent Application Publication
(10) Pub. No.: US 2014/0377033 A1
(43) Pub. Date: Dec. 25, 2014

(54) STRUCTURE FOR RELEASE PREVENTING

(71) Applicant: HYUNDAI MOBIS CO., LTD., Seoul (KR)

(72) Inventor: Chul Soon IM, Yongin-si (KR)

(73) Assignee: HYUNDAI MOBIS CO., LTD., Seoul (KR)

(21) Appl. No.: 14/252,141

(22) Filed: Apr. 14, 2014

(30) Foreign Application Priority Data
Jun. 20, 2013 (KR) 10-2013-0070826

(51) Int. Cl. F16B 39/24

(52) U.S. Cl. CPC F16B 39/24
USPC 411/223

(57) ABSTRACT

The present invention relates to a fastening structure for release prevention, and more particularly, to a fastening structure for release prevention which may prevent a bolt and a nut from being released due to an external impact, and provides a fastening structure for release prevention including: a release prevention washer which is formed in a ring shape, and has a plurality of projections that protrudes on both surfaces of the release prevention washer in a radial direction from a center; and a nut which has a plurality of grooves that corresponds to the plurality of projections formed on the surfaces of the release prevention washer.

### CROSS-REFERENCE TO RELATED APPLICATION

This application claims priority to and the benefit of Korean Patent Application No. 10-2013-0070826 filed in the Korean Intellectual Property Office on Jun. 20, 2013, the entire contents of which are incorporated herein by reference.

### TECHNICAL FIELD

The present invention relates to a fastening structure for release prevention, and more particularly, to a fastening structure for release prevention which may prevent a bolt and a nut from being released due to an external impact.

### BACKGROUND OF THE INVENTION

In general, in order to fasten assembly components, bolts and nuts are used.

The bolt and the nut are means for fixing the assembly components, and the bolt penetrates holes of the stacked assembly components so as to be fastened to the nut, and the respective assembly components are assembled by fastening force that is produced when the bolt and the nut are fastened.

However, there is a problem in that the bolt and the nut may be released due to an external impact or vibration. The bolt and the nut, which are used to fasten components in a vehicle, may be released while being rotated, because of a fluctuating load such as a shearing load and a tensile load, or a vibrational load, and the release of the bolt and the nut may cause problems in regards to safety, reliability, precision maintenance, and connections in a vehicle. That is, the release of the bolt and the nut may degrade durability of the assembly components.

In order to resolve the problem with the release of the bolt and the nut, the bolt and the nut are fixed by additionally inserting a spring washer 130 and a flat washer 140 between a bolt 110 and an assembly component 120, as illustrated in FIG. 1, but there is a problem in that the release of the assembly components due to vibration may not be prevented.

As illustrated in FIG. 2, the bolt 110 is coupled after an adhesive 150 such as Loctite or sealant is applied onto a threaded portion of the bolt 110, but this causes a problem in that a process of applying the adhesive onto the threaded portion of the bolt is additionally required.

### SUMMARY OF THE INVENTION

The present invention has been made in an effort to provide a fastening structure for release prevention in which projections are formed on surfaces of a release prevention washer, grooves, into which the projections of the release prevention washer are inserted, are formed in surfaces of a bolt, an assembly component, and a nut, and the release prevention washers are inserted and fixed between the bolt and the assembly component, and between the assembly component and the nut, thereby preventing the bolt and the nut from being released.

The present invention has also been made in an effort to provide a fastening structure for release prevention in which a bolt, release prevention washers, assembly components, and a nut are simultaneously assembled when the assembly components are assembled, such that the assembling process is easy.

An exemplary embodiment of the present invention provides a fastening structure for release prevention including: a release prevention washer which is formed in a ring shape, and has a plurality of projections that protrudes on both surfaces of the release prevention washer in a radial direction from a center; and a nut which has a plurality of grooves that corresponds to the plurality of projections formed on the surfaces of the release prevention washer.

In addition, in the present invention, a plurality of grooves, which corresponds to the plurality of projections, may be formed in surfaces of an assembly component and a bolt which come into contact with the release prevention washer.

In addition, in the present invention, the plurality of projections formed on the release prevention washer each may have a projection surface which is caught by the groove, and an inclined surface which is inclined in a direction from the projection surface toward the surface of the release prevention washer.

In addition, in the present invention, the plurality of grooves each may have a catching projection on which the projection surface is caught, and an inclined surface which is inclined in a direction from the surfaces of the assembly component, the bolt, and the nut toward the catching projection.

In addition, in the present invention, the plurality of projections formed on both the surfaces of the release prevention washer may be alternately formed.

According to the fastening structure for release prevention of the present invention, the projections are formed on both the surfaces of the release prevention washer, and the grooves, which correspond to the projections of the release prevention washer, are formed in the surfaces of the bolt, the assembly component, and the nut so as to correspond to the release prevention washer, such that the projections of the release prevention washers are engaged with and fixed to the grooves, thereby securely fixing the bolt and the assembly component, and the assembly component and the nut, and preventing the bolt and the nut from being released.

In addition, according to the fastening structure for release prevention of the present invention, since the bolt, the release prevention washers, the assembly components, and the nut are simultaneously assembled when the assembly components are assembled, the assembling process is easy.

### BRIEF DESCRIPTION OF THE DRAWINGS

FIG. 1 is a view illustrating a structure for fastening an assembly component using a bolt and a nut according to an exemplary embodiment in the related art.

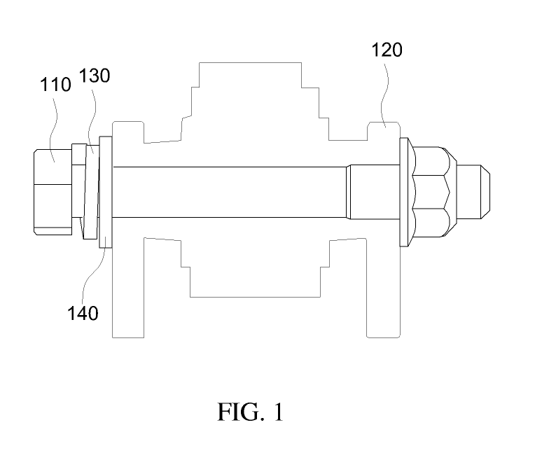

FIG. 2 is a view illustrating a structure for fastening an assembly component using a bolt and a nut according to another exemplary embodiment in the related art.

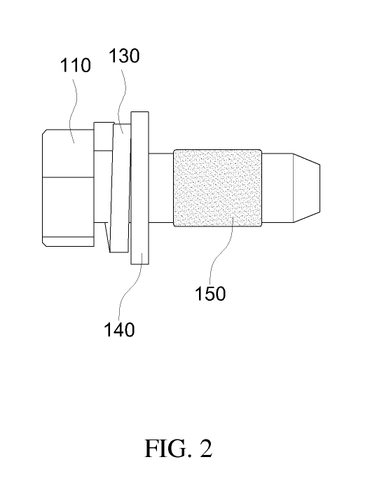

FIGS. 3A and 3B are views illustrating a release prevention washer of a fastening structure for release prevention according to the present invention.

FIG. 4 is a view illustrating a bolt, a nut, and an assembly component of the fastening structure for release prevention according to the present invention.

FIG. 5 is a view illustrating the fastening structure for release prevention according to the present invention.

FIG. 6 is a view illustrating a cross section of the fastening structure for release prevention according to the present invention.

### DETAILED DESCRIPTION OF THE EMBODIMENTS

Hereinafter, an exemplary embodiment of the present invention will be described in detail with reference to the accompanying drawings and the following contents. However, the present invention is not limited to the exemplary embodiments described herein, and may be implemented in various different forms. The exemplary embodiment introduced herein is provided so that the disclosed contents can be thoroughly complete, and the spirit of the present invention can be fully recognized by those skilled in the art. Like reference numerals refer to like elements throughout the specification.

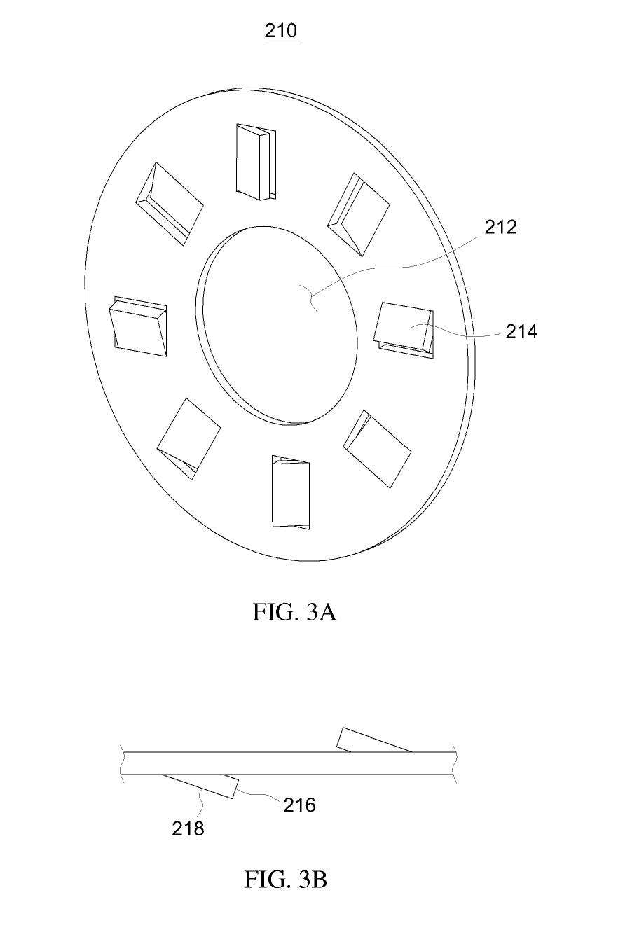

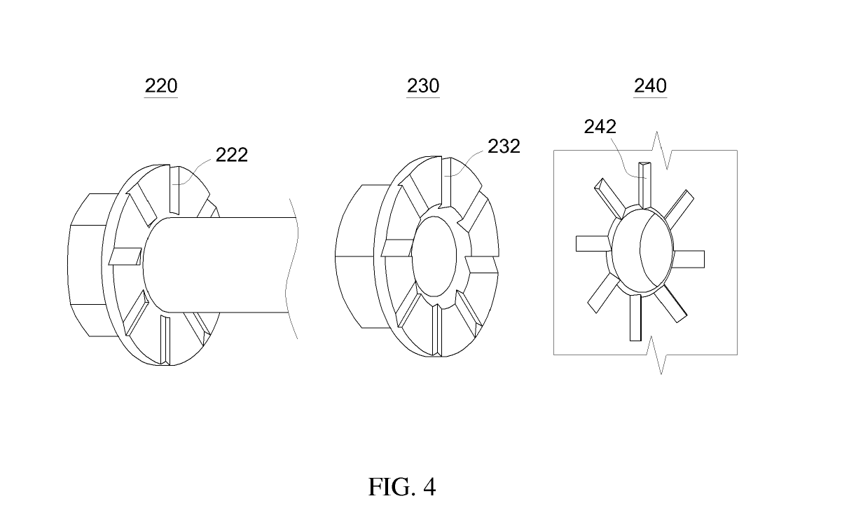

FIGS. 3A and 3B are views illustrating a release prevention washer of a fastening structure for release prevention according to the present invention, and FIG. 4 is a view illustrating a bolt, a nut, and an assembly component of the fastening structure for release prevention according to the present invention.

As illustrated in FIG. 3A, a release prevention washer 210 may have a through portion 212 that is formed in a circular shape at a center of the release prevention washer 210 so that a bolt 220 penetrates the through portion 212, and a plurality of projections 214 may be formed to protrude on both surfaces of the release prevention washer 210 in a radial direction from the through portion 212.

Here, the plurality of projections 214 each may have a projection surface 216 which protrudes from the surface of the release prevention washer 210, and an inclined surface 218 which is inclined in a direction from the projection surface 216 toward the surface of the release prevention washer 210.

In addition, as illustrated in FIG. 3B, the inclined surfaces 218 of the plurality of projections 210 formed on both the surfaces may be inclined in opposite directions. That is, the inclined surface 218 formed on one surface of the release prevention washer 210 may be formed to be inclined in one direction, and the inclined surface 218 formed on the other surface of the release prevention washer 210 may be formed to be inclined in the other direction.

In addition, the plurality of projections 214 formed on both the surfaces of the release prevention washer 210 may be alternately formed.

In addition, the release prevention washer 210 having the plurality of projections may be formed by a press process. The press process is a method of manufacturing a predetermined panel by mounting a mold having a shape of the release prevention washer 210 between press machines that reciprocate upward and downward, and plastically deforming the mold. The release prevention washer 210, which has the plurality of projections on both the surfaces, may be produced by forming a metallic material by drawing, bending, and cutting processes, using the press machine and the mold.

As illustrated in FIG. 4, grooves 222, 232, and 242, which have shapes that correspond to those of the plurality of projections 214 formed on the release prevention washer 210, may be formed in a bolt 220, an assembly component 230, and a nut 240.

That is, the release prevention washers 210 are provided between the bolt 220 and the assembly component 240, and between the assembly component 240 and the nut 230, and thus the plurality of grooves 222, 232, and 242, which have shapes that correspond to those of the plurality of projections 214, may be formed in surfaces that come into contact with the release prevention washers 210, that is, a surface of the bolt 220, a surface of the assembly component 240, and a surface of the nut 230, such that the plurality of grooves 222, 232, and 242 may be engaged with and coupled to the plurality of projections 214 formed on the release prevention washers 210.

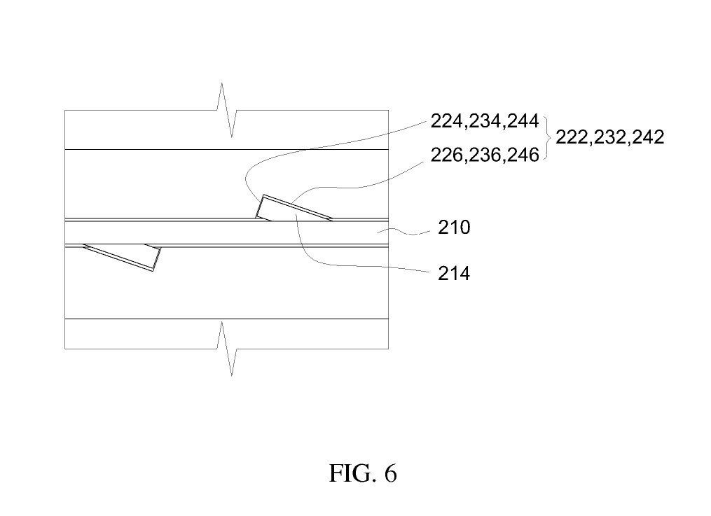

In addition, the plurality of grooves 222, 232, and 242, which is formed in the surface of the bolt 220, the surface of the assembly component 240, and the surface of the nut 230, each may have a catching projection (224, 234, and 244 in FIG. 6) on which the projection surface 216 is caught, and an inclined surface (226, 236, and 246 in FIG. 6) that is inclined in a direction from the surfaces of the bolt 220, the assembly component 240, and the nut 230 toward the catching projection (224, 234, and 244 in FIG. 6).

A process of fastening the release prevention washer 210, the bolt 220, the assembly component 240, and the nut 230, which have the aforementioned configurations, will be described with reference to the following drawings.

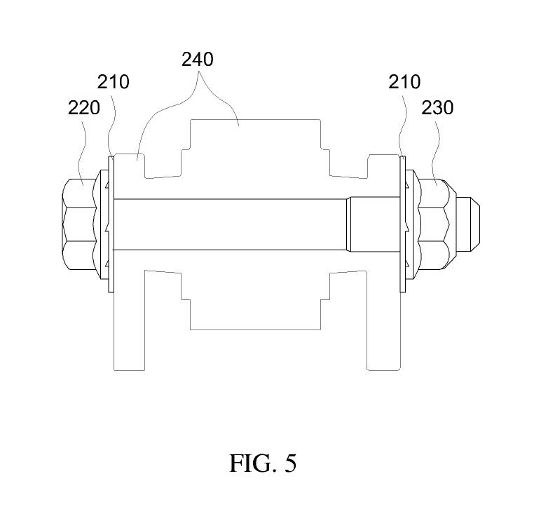

FIG. 5 is a view illustrating the fastening structure for release prevention according to the present invention, and FIG. 6 is a view illustrating a cross section of the fastening structure for release prevention according to the present invention.

As illustrated in FIG. 5, a thread of the bolt 220 penetrates the through portion 212 of the release prevention washer 210, passes through holes formed in the assembly components 240, penetrates the through portion 212 of another release prevention washer 210, and is inserted into the nut 230. When the bolt 220 is rotated, the nut 230 is fixed while being rotated in the opposite direction.

In this case, as illustrated in FIG. 6, by the rotation of the bolt 220 and the nut 230, the projection surfaces 216 of the plurality of projections 214 formed on both the surfaces of the release prevention washer 210 are engaged with the catching projections 226, 236, and 246 of the plurality of grooves 222, 232, and 242 formed in the surface of the bolt 220, the surface of the nut 230, and the surface of the assembly component 240, such that the bolt 220, the release prevention washer 210, the assembly component 240, and the nut 230 may be fastened.

Here, when the bolt 220 and the nut 230 begin to be released due to vibration of a vehicle, the projection surfaces 216 formed on the plurality of projections 214 are caught by the catching projections 226, 236, and 246 of the plurality of grooves 222, 232, and 242 formed in the bolt 220, the nut 230, and the assembly component 240, thereby preventing the bolt 220 and the nut 230 from being released.

Meanwhile, the configuration in which the plurality of grooves is formed in the surfaces of the bolt 220, the nut 230, and the assembly component 240 is described and illustrated in the detailed description and the drawings of the present invention, but the present invention is not limited thereto. For example, the plurality of grooves 222, 232, and 242 may be formed only in the surface of one of the bolt 220, the nut 230, and the assembly component 240, and the plurality of grooves may be formed in any surface as long as the surface comes into contact with the release prevention washer 210.

As described above, according to the fastening structure for release prevention according to the exemplary embodiment of the present invention, the projections 214 are formed on both the surfaces of the release prevention washer 210, and the grooves 222, 232, and 242 are formed in the surfaces of the bolt 220, the assembly component 240, and the nut 230 so as to correspond to the release prevention washer 210, such that the projections 214 of the release prevention washers 210 are engaged with and fixed to the grooves 222, 232, and 242, thereby securely fixing the bolt and the assembly component, and the assembly component and the nut, and preventing the bolt and the nut from being released.

In addition, when the assembly components are assembled, the bolt, the release prevention washer, the assembly components, and the nut are simultaneously assembled, and as a result, the assembling process is easy.

While the fastening structure for release prevention of the present invention has been described above based on the exemplary embodiment of the present invention, it will be apparent to those skilled in the art that various modifications, changes and substitutions of the exemplary embodiment are possible without departing from the spirit of the present invention.

### DESCRIPTION OF REFERENCE NUMERALS

210: Release prevention washer

212: Through portion

214: Projection

216: Projection surface

218: Inclined surface

220: Bolt

230: Nut

240: Assembly component

222, 232, 242: Groove

224, 234, 244: Catching projection

226, 236, 246: Inclined surface

What is claimed is:

1. A fastening structure for release prevention comprising:
a release prevention washer which is formed in a ring shape, and has a plurality of projections that protrudes on both surfaces of the release prevention washer in a radial direction from a center; and
a nut which has a plurality of grooves that corresponds to the plurality of projections formed on the surfaces of the release prevention washer.

2. The fastening structure of claim 1, wherein a plurality of grooves, which corresponds to the plurality of projections, is formed in surfaces of an assembly component and a bolt which come into contact with the release prevention washer.

3. The fastening structure of claim 2, wherein the plurality of projections formed on the release prevention washer each has a projection surface which is caught by the groove, and an inclined surface which is inclined in a direction from the projection surface toward the surface of the release prevention washer.

4. The fastening structure of claim 3, wherein the plurality of grooves each has a catching projection on which the projection surface is caught, and an inclined surface which is inclined in a direction from the surfaces of the assembly component, the bolt, and the nut toward the catching projection.

5. The fastening structure of claim 3, wherein the plurality of projections formed on both the surfaces of the release prevention washer is alternately formed.
